(19) United States
(12) Patent Application Publication
(10) Pub. No.: US 2016/0113733 A1
(43) Pub. Date: Apr. 28, 2016

(54) Fluid Bypass Device for Handheld Dental Devices

(71) Applicant: Inter-Med, Inc., Racine, WI (US)

(72) Inventors: Gary J. Pond, Milwaukee, WI (US); John Baeten, Oak Creek, WI (US)

(21) Appl. No.: 14/984,658

(22) Filed: Dec. 30, 2015

Related U.S. Application Data
(63) Continuation of application No. 12/313,366, filed on Nov. 19, 2008, now abandoned.
(60) Provisional application No. 61/066,430, filed on Feb. 20, 2008.

(51) Int. Cl. A61C 1/00; A61C 5/02; A61C 1/08; A61C 17/20

(52) U.S. Cl. CPC A61C 1/0084; A61C 17/20; A61C 5/02; A61C 1/08

(57) ABSTRACT

A bypass device and kit for delivering a fluid to a dental area for use with a dental handpiece. The device comprises a fluid reservoir, a length of hollow tubing that will be attached externally to the handpiece, and a nosepiece connected to the tubing. Fluid is delivered to, the dental area through the nosepiece, independently of the dental handpiece.

### RELATED APPLICATIONS

The present application claims priority to U.S. provisional patent application, Ser. No. 61/066,430 filed on 20 Feb. 2008.

### BACKGROUND OF THE INVENTION

The present invention relates to handheld devices for performing dental procedures and, more specifically, to ultrasonic and endodontic devices used for performing dental procedures such as root canals.

Endodontic or root canal therapy is a common procedure in which a dentist or endodontist removes the nerve and dental pulp from a tooth in cases where the nerve has been damaged by a cavity, trauma (e.g., fracture of the tooth), disease (e.g., infection), or other reasons. This procedure not only allows the individual to keep a tooth that otherwise might have needed removal, but relieves the individual of pain and discomfort.

A variety of tools have been developed for endodontic processes and other dental treatments. Most notably, these include devices that deliver ultrasonic energy to the root canal area. The devices have a needle tip that receives ultrasonic energy, which assists in breaking up and removing damaged material from the root canal, thereby treating the tooth.

Likewise, a variety of biochemical treatments have been employed to chemically attack and decompose the nervous bundle or necrotic magma. For example, sodium hypochlorite (NaOCl) solutions are commonly employed as a treatment solution that is introduced into the pulp chamber and pulp canals to chemically treat dental roots. Generally, such treatment solutions are passed through the body of the ultrasonic tool and exit through a needle attached to the tool. However, this can lead to agitation of the solution, which can lead to unnecessary and unwanted air pockets or bubbles in the solution.

Improved dental processes and apparatuses include both ultrasonic energy and alternative solution delivery systems. Such an example can be found in U.S. Pat. No. 6,948,935, issued to Nusstein. The device comprises an ultrasonic handpiece having a needle for the delivery of ultrasonic energy and a secondary needle for delivery of the hypochlorite solution. The secondary needle intersects the shaft of the ultrasonic needle, so that the NaOCl solution will be delivered to the dental site, directly through the secondary needle. The delivery of the solution is integral with needle of the handpiece. The device requires a specific needle and needle arrangement to allow the secondary needle to deliver fluid through the shaft of the ultrasonic needle. That is, devices having standard needle arrangements would not be used in the device according to Nusstein, as they do not have an arrangement for a second needle to intersect the shaft of the needle of the dental tool. Similarly, the intersection of the secondary needle with the needle of the handpiece can lead to an awkward tool arrangement for handling purposes.

Thus, it is desirable to provide a way for delivering a fluid in connection with a dental handpiece that could provide a greater range of uses than with a specifically arranged device that does not require any specific needles and the like. That is, it would be beneficial to provide a fluid delivery system adaptable for various dental handpieces, wherein the fluid is delivered externally of the handpiece.

### SUMMARY OF THE INVENTION

The present invention comprises a fluid bypass system that can be used in conjunction with an ultrasonic handpiece or other dental handpiece that will deliver fluid externally and independently of the handpiece.

The device comprises a fluid reservoir, a length of hollow tubing having a first end and a second end, with the first end being in fluid communication with the fluid reservoir. The device also has means for externally attaching the tubing to the main body of the dental handpiece and a nosepiece connected to the second end of the tubing, with the nosepiece having a nozzle. The device has means for delivering fluid from the reservoir through the nozzle, wherein the nosepiece is situated so that fluid is capable of being delivered upon the external surface of the needle shaft of the dental handpiece when the device is attached to the dental handpiece.

Alternatively, the device can be arranged so that fluid is delivered externally of the handpiece, with an arrangement that connects the tubing to a removable nosepiece. The nosepiece would have a fluid pathway that would join the tubing to the needle, independently of the handpiece.

The nosepiece itself provides a design that allows fluid to bypass the ultrasonic device. The needle connected to the nosepiece may be a flexible needle that can be designed to further transmit ultrasonic energy or sonic energy. The flexible needle preferably has a portion thereof that is comprised of a plastic material.

The invention also comprises a kit that includes the device.

### BRIEF DESCRIPTION OF THE DRAWINGS

FIG. 1 is a perspective view of a fluid delivery device according to the present invention.

FIG. 2 is an exploded view of the device according to FIG. 1.

FIG. 3 is a perspective view of the device of FIG. 1 delivering fluid into a dental cavity.

FIG. 4 is an overhead view of a kit including the device of FIG. 1.

FIG. 5 is an exploded perspective view of a second embodiment of a fluid delivery device according to the present invention.

FIG. 6 is a partial side view of the device shown in FIG. 5.

FIGS. 7 is a further arrangement of the second embodiment, showing a specific flexible needle arrangement.

FIG. 8 is a further view of the arrangement of FIG. 7, with the needle being sized to a particular length.

FIG. 9 is an enlarged view of the needle shown in FIGS. 7 and 8.

FIG. 10 depicts the device of FIG. 7 delivering a fluid into a dental cavity, with the flexible needle being inserted substantially into a root canal near the apex of the root canal.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

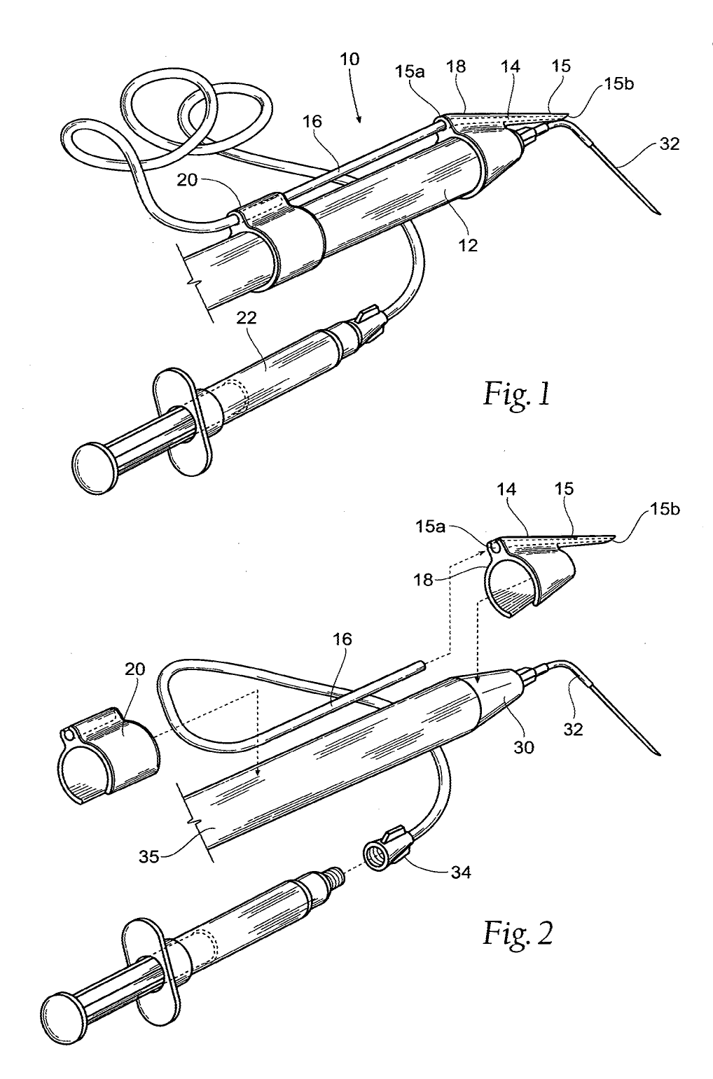

FIG. 1 provides a fluid dispensing device 10 according to the present invention. The dispensing device 10 provides an adaptable fluid bypass that can provide fluid to a dental area, such as a root canal, independently and externally of a dental handpiece, while being attachable to that handpiece. The dispensing assembly 10 is connected to a dental handpiece 12, which could be any of a variety of devices, such as ultrasonic scalers, endodontic devices, or other handheld dental devices used in dental procedures. The assembly 10 comprises a nosepiece 14 connected to a tubing 16, which is preferably a flexible type of tubing. A first clip 18 attaches the nosepiece 14 and the tubing 16 to the handpiece 12.

The nosepiece 14 generally comprises a nozzle 15 having a first end 15a and a second end 15b. The first end 15a of the tubing is in fluid communication with the tubing 16, and the second end 15b allows fluid flow through the nozzle 15 onto the exterior surface of a needle 32. Preferably the tubing 16 is fittingly secured within the first end 15a, with the first end 15a being sized to securely retain the tubing 16 within the inner diameter of the first end 15a. However, any arrangement that will provide a fluid tight arrangement should fall within the scope of the present invention. It is also contemplated that the tubing 16 could be secured to the first end 15a with an adhesive, welding, or other retaining material. The nosepiece 14, the nozzle 15, and the first clip 18 are shown as an integral or unitary one-piece construction, but it is possible that they could be manufactured as separate elements and still fall within the scope of the present invention. Provided that the arrangement allows for a fluid tight flow from the tubing 16 onto the exterior surface of the needle 32, the arrangement would fall within the scope of the present invention.

A second clip 20 will further attach the tubing 16 to the handpiece 12. It is possible that more or fewer clips could be used to attach the tubing 16 to the handpiece 12. Preferably the clips 18, 20 are positioned that the tubing 16 is attached relatively smoothly along the elongated body of the handpiece 12. Similarly, other attachment means could be used to attach the tubing to the handpiece 12. The tubing 16 is connected to a syringe 22, which houses a fluid, such as sodium hypochlorite (NaOCl) or other fluid used in dental procedures. While a syringe 22 is shown, it is possible that another type or style of a reservoir could be used to store the fluid.

FIG. 2 provides an exploded view of the assembly 10. The nosepiece 14 comprises the nozzle 15 having the first end 15a and the second end 15b. As previously noted, the nosepiece 14 is attached to a front end 30 of the handpiece 12 by way of the first clip 18. The front delivery section 14 is attached in such a fashion that the second end 15b of the nozzle 15 is situated over the needle 32, which is connected to the front end 30 of the handpiece 12. The arrangement allows for fluid to exit the second end 15b onto the outside of the needle 32 when the assembly 10 is in use. The nosepiece 14 and the first clip 18 could be designed as separate sections or they could be preassembled as a single part, either molded together or separately formed and then preassembled. Likewise, the first clip 18 could be designed to slide over the front end 30 of the handpiece 12 (FIG. 1), or snapped on to the handpiece 12, as would be evident as shown in FIG. 2.

Still referring to FIG. 2, the nosepiece 14 will be connected to the tubing 16, preferably in a fluid tight arrangement. The tubing 16 generally extends the length of the handpiece 12 and is further attached near the back end 35 of the handpiece 12 with the second clip 20. As with the first clip 18, the second clip 20 can be of varying connection arrangements. The tubing 16 is preferably drawn fairly taut to the length of the handpiece 12 to minimize any problems with pinching or snagging of the tubing 16 when in use. It may be possible to shorten or cut the tubing 16 if desired so that the path of the fluid through the tubing 16 is shorter and possibly more easily controlled. The tubing 16 is attached to the syringe 22 with locking means 34 so that a fluid tight arrangement will be present from the syringe 22 to the tubing 16. The locking means 34 could take the form of a press-fit device, a screw-type device, a LUER® locking device, or other means that will provide a fluid tight arrangement from the syringe 22 to the tubing 16. The locking means 34 could be releasably attached or secured to the syringe with an adhesive, welding, or other means.

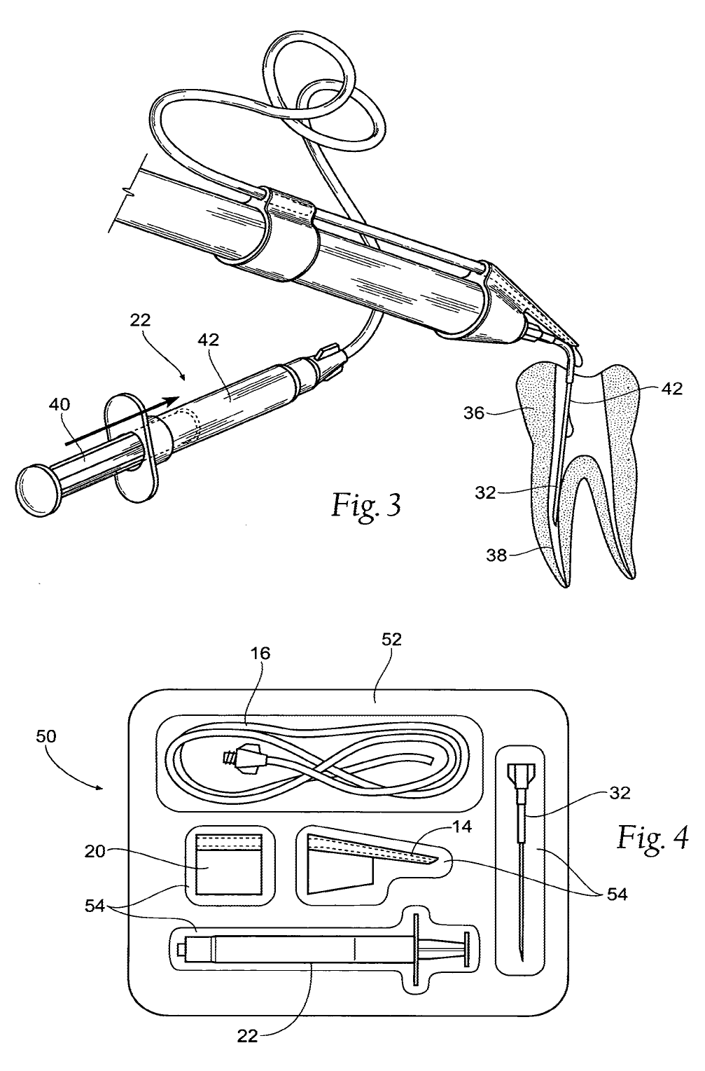

FIG. 3 shows the assembly 10 being used within a tooth 36 and a root canal 38. As the needle 32 of the handpiece 12 is inserted into the root canal 38 to perform a dental procedure, a plunger 40 is depressed inwardly into the fluid reservoir 42 of the syringe 22, thereby allowing fluid to be expelled from the syringe 22, through the tubing 16, and exit the nosepiece 14 through the nozzle 15 onto the outside surface of the needle 32. The fluid will move down the shaft 42 of the needle 32 in a useful manner, thereby entering the root canal 38. The arrangement and positioning of the nosepiece 14 specifically allows fluid to enter the root canal 38 in a sufficiently close proximity to the needle 32, without requiring an arrangement that requires positioning of the nosepiece 14 and the assembly 10 so that the nozzle 15 intersects the needle 32. Likewise, the nosepiece 14 and the nozzle 15 can be of various shapes and configurations, provided that arrangement is capable of allowing fluid to flow from a fluid reservoir onto the needle of the dental tool, while still being arranged to be attached to the dental handpiece 12. Furthermore, the present invention can be properly used with either a solid needle or a hollow needle, which is a further advantage over the prior art.

FIG. 4 shows a package construction 50 for the assembly 10. The package construction 50 generally comprises a tray 52 having various cavities 54 for housing the various components of the assembly 10.

Preferably, the compartments are relatively sized to receive and store the individual components. For example, the syringe 22, the nosepiece 14, second clip 20, the tubing 16, and the needle 32 are shown in various cavities 54. The package construction 50 could be of other arrangements as well, depending on whether the various clips and connections are designed as unitary or separate elements, as discussed above. For instance, the syringe 22 could be preassembled with the tubing 16, the tubing 16 could be preassembled with the nosepiece 14 and/or the first clip 18 (see FIG. 1), and other possible combinations. The syringe 22 could also be prefilled with a dental solution.

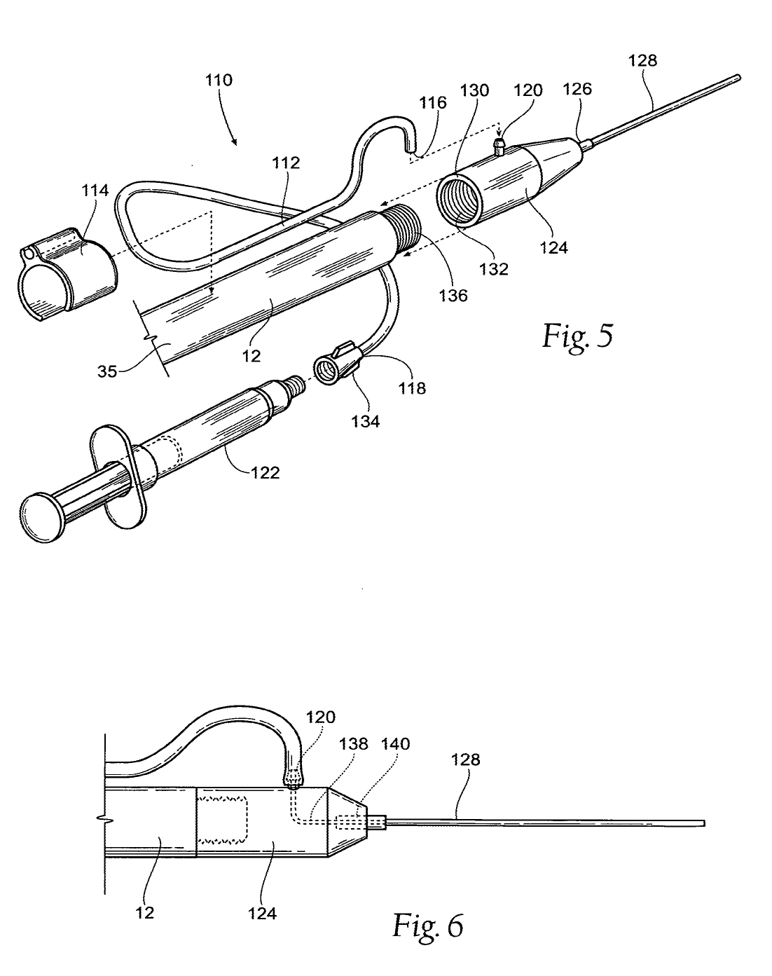

FIGS. 5 and 6 demonstrate a second embodiment 110 of a fluid dispensing device according to the present invention. The fluid dispensing device 110 generally comprises a tubing 112 and means for securing the tubing to the handpiece 12, such as a clip 114, similar to the previously described securing means and clip 20 in FIGS. 1-4. The tubing 112 has a first end 116 and a second end 118, with the second end 118 being attached to a syringe 122 by way of locking means 134, as was discussed with respect to the first embodiment. The first end 116 is capable of attaching to attachment means 120, which is preferably a hollow fitting, located on a front nosepiece 124. The attachment means 120 is preferably a press fitting that is sized so that the tubing 116 and the fitting 120 will form a fluid-tight relationship. It is understood that any fitting, such as a press fitting, clamp, or other arrangement, that will securely connect the tubing 116 to the nosepiece 124 will fall within the scope of the present invention.

The front nosepiece 124 has a first end 126 attached to a needle 128 and a second end 130 that will connect the nosepiece 124 to the handpiece 12. The second end 130 has an internally threaded area 132 that will mate with an externally threaded area 136 located on the handpiece 12. The arrangement and connection of the nosepiece 124 to the handpiece 12 allows ultrasonic energy to travel from the handpiece 12 to the nosepiece 124 and eventually to the needle 128.

FIG. 6 shows a side view of the handpiece 12 connected to the nosepiece 124. As shown in phantom, the nosepiece 124 has an internal fluid pathway 138 that connects the tubing 112 to a port 140 that receives the needle 128. Fluid will be able to pass from the tubing 116, through the attachment means or fitting 120, and through the fluid pathway 138 to the port 140. The needle 128 is secured within the port 140 so that it preferably forms a fluid tight arrangement, such as having the needle 128 force fitted into the port 140 and then crimped into place. Alternatively, the needle 128 could be glued into place within the port 140, or connected by other known means. The fluid pathway 138 allows fluid to pass from the syringe 122 (FIG. 5) to the needle 128 in a fluid tight fashion, as was described with respect to embodiment 1. The fluid is delivered independently to the needle 128, without the fluid passing through the ultrasonic handpiece 12.

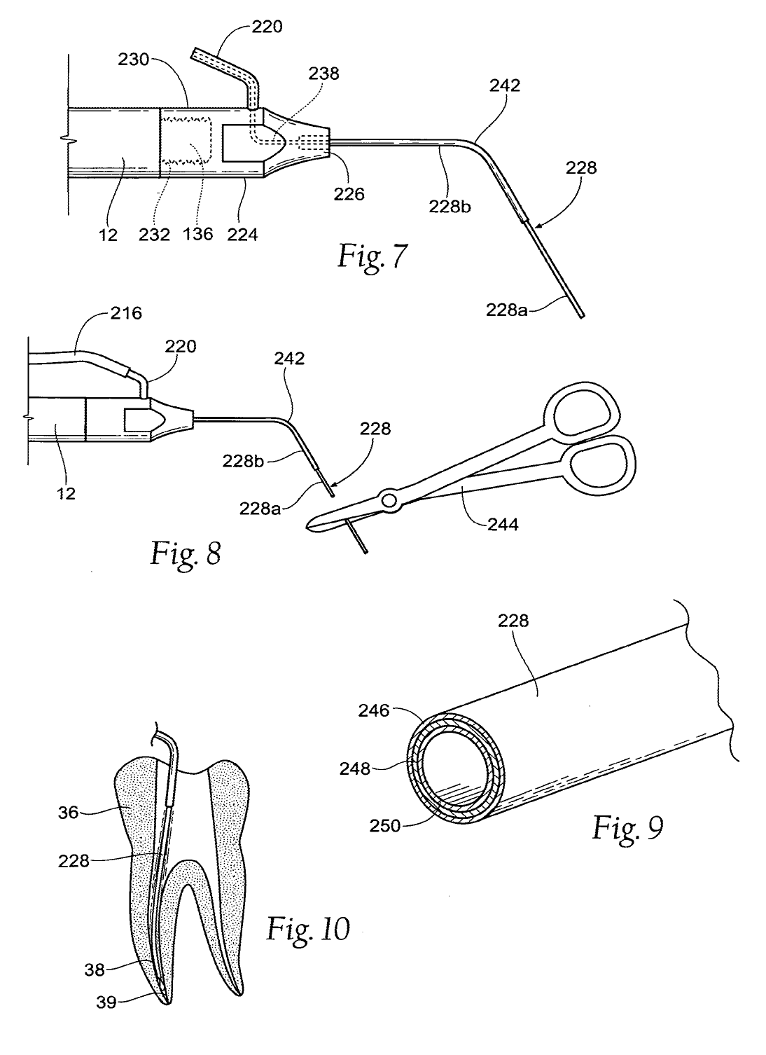

FIGS. 7 and 8 provide a further arrangement of the second embodiment 110, with an alternate nosepiece 224. The nosepiece 224 has generally the same arrangement as the nosepiece 124. The nosepiece has a fitting 220 that acts as means for connecting the nosepiece to the fluid reserve. As shown, the fitting 220 is designed to receive a tubing 216, similarly as shown with respect to the fitting 120 and tubing 116 shown in FIGS. 5 and 6. The fitting 220 extends a longer distance than the fitting 120, but similarly mates with the tubing 216 to form a fluid tight arrangement for delivering fluid from the fluid reservoir 22 (see FIG. 1) to the nosepiece 224.

Still referring to FIGS. 7 and 8, the nosepiece 224 has a first end 226 that receives a needle 228, and a second end 230 having an internally threaded area 232. The internally threaded area 232 is arranged to mate with the threaded area 136 of the handpiece 12. As shown in phantom in FIG. 7, the nosepiece 224 has an internal fluid pathway 238 that connects the tubing 216 to a port 240 that receives the needle 228. Fluid will be able to pass from the tubing 112, through the attachment means or fitting 220, and through the fluid pathway 238 to the port 240. The needle 228 is secured within the port 240 so that it preferably forms a fluid tight arrangement, as described with respect to the needle 128 and the port 140 shown in FIG. 6.

The needle 228 generally has a first section 228a and a second section 228b, with the second section 228b being covered by a cannula 242. The needle 228 is shown bent, but the needle 228 may be straight, if desired. The needle 228 is a flexible design that allows the needle to bend according to the shape of a root canal (see FIG. 10). A flexible needle should be understood as being a needle that can be bent to various shapes, but will return to the original shape of the needle, unless an external force is applied to the needle 228. The inclusion of the cannula 242 over the second section 228b of the needle 228 allows the needle to retain a relatively stable shape, while still allowing the first section 228a to be flexible when inserted into the root canal 36. That is, the cannula 242 allows the needle 228 to be prebent at a desired angle while still allowing the first section 228a of the needle to retain its flexibility. The cannula 242 is preferably comprised of a bendable material, for example a metal material, such as a stainless steel, but could be of any material that will hold the needle 228 in a specific position, as understood in the art. Generally, the cannula 242 can be referred as an angle adjustment sleeve. Non-limiting examples of such sleeves are shown in U.S. Pat. No. 6,494,713, which is incorporated herein by reference. It is understood that the cannula 242 refers to any device that can retain a portion of the needle 228 in a prebent position.

As shown in FIG. 8, a pair of scissors 244 is shown cutting the needle 228. The design of the needle 228 allows for altering the length of the needle 228, which is an advantage over prior art designs. Because different root canals have different lengths and shapes, a needle of one-size may not be of proper size for varying root canals. The present invention allows the user to adapt the needle 228 as necessary by allowing the user to cut the needle 228 to a desired working length. The needle 228 is designed of a material that allows for the length of the needle to be altered with common items that may be used or found within a dental office or similar place, such as scissors, scalpels, knifes, or other common items.

FIG. 9 is a close-up view of the needle 228. The needle 228 comprises three layers: an outer layer 246, a central layer 248, and an inner layer 250. The inner layer 250 is formed of a plastic material, preferably a thermoplastic material, such as a polyimide based material, a fluoroplastic material, or a polymer or fluoropolymer, such as polytetrafluoroethylene (PTFE) or fluorinated ethylene propylene (FEP), or a similar flexible material or blend of such materials. The central layer 248 is made of a flexible metal material, such as a flexible stainless steel, with the central layer 248 being attached to the inner layer 250 in any of a number of various ways, such as braiding, coiling, wrapping, etc. One example of an acceptable type of metal material is stainless steel 304V. However, any metal material known that provides flexibility and strength, including shape memory metals and alloys thereof, composites or equivalents thereof, would be considered capable for use as the central layer 248. The outer layer 246 is also formed of a flexible material, such as a nylon, urethane, or other flexible material similar to that of the inner layer 250, potentially being the same or a different material than the inner layer 250. The outer layer 246 is preferably coated or sprayed over the center layer 248.

Each of the three individual layers of the needle 228 is of a flexible material. The arrangement of the needle 228 allows for a flexible material that is still capable of delivering ultrasonic energy to the dental cavity, with the fluid being delivered separately and externally of the dental handpiece 12 to the dental cavity.

The use of the nosepiece 224 and the flexible needle 228 allows for improved ultrasonic action with the root canal 38, while minimizing any bubbling or agitation of the delivered fluid, as potentially happened with prior art devices. Also, as depicted in FIG. 10, the use of the flexible needle 228 minimizes any damage or puncturing of the root canal 38 when the nosepiece 224 is being used, not only because the needle 228 can adapt to the shape and curvature of the canal 38, but also because the needle 228 is capable of agitation while still being a short distance away from the walls of the canal 38. The needle 228 of the present invention has several advantages over the prior art.

For example, the ability of a needle comprised of a flexible, plastic material has previously not been known to be used to transfer ultrasonic energy to a dental area, such as the root canal 38, shown in FIG. 10. When compared with prior art needles, the needle 228 significantly reduces erosion or destruction of dentin within the canal 38. As shown in FIG. 10, the flexibility of the needle 228 provides for insertion of the needle 228 further within the canal 38, near the apex 39 of the canal 38. Prior art needles are not capable of such insertion; that is the prior art needles do not have the flexibility needed for insertion into the canal 38 as shown, with the needle still being capable of transmitting ultrasonic energy. The present invention provides a flexible needle that, is capable of transmitting ultrasonic or sonic energy through the shaft of the needle 228 and converting that energy to mechanical energy at the tip of the needle.

The present invention provides a simple to use fluid bypass delivery device that can be used in connection with a variety of dental tools without needing specialized needles or tips for the device to work properly. The device and kit may also allow fluid to be delivered into a dental canal or cavity without unnecessary agitation of the fluid, as was demonstrated with respect to the first embodiment, thereby reducing the potential of unwanted bubbles or air pockets in the fluid that potentially could cause undue problems within the root canal.

As discussed, the present invention is related to dental tools that it should be understood that the present invention is directed towards devices that transmit energy, as described. That is, while the present invention is directed towards devices that are described as using ultrasonic energy, the present invention could be used with devices that transfer sonic energy and other electromechanical energy forms.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A device for delivering a fluid to a dental area for use with a dental handpiece, said dental handpiece comprising a main body and a dental needle extending axially therefrom, said dental needle comprising a shaft, said device comprising:
a fluid reservoir;
a length of hollow tubing having a first end and a second end, said first end of said tubing in fluid communication with said fluid reservoir;
means for externally attaching said tubing to said main body of said dental handpiece;
a nosepiece connected to said second end of said length of tubing, said nosepiece comprising a nozzle;
means for delivering fluid from said reservoir through said nozzle, wherein said nosepiece is situated so that fluid is capable of being delivered upon the external surface of said shaft of said needle when said device is attached to said dental handpiece.

2. The device according to claim 1 wherein said fluid reservoir comprises a syringe.

3. The device according to claim 1 wherein said attaching means comprises at least two clips.

4. The device according to claim 1 wherein said nosepiece is removably securable to said tubing.

5. The device according to claim 1 wherein said nosepiece is preassembled with said tubing.

6. A device for delivering a fluid to a dental area for use with an ultrasonic dental handpiece, said dental handpiece comprising a main body, said device comprising:
a fluid reservoir;
a length of hollow tubing having a first end and a second end, said first end of said tubing in fluid communication with said fluid reservoir;
means for externally attaching said tubing to said main body of said dental handpiece;
a nosepiece having a first end and a second, said nosepiece comprising:
means for attaching said second end of said length of tubing to said nosepiece;
means for releasably connecting said nosepiece to said main body, said means located at said second end of said nosepiece;
a port located on said first end of said nosepiece;
a fluid pathway connecting said second end of tubing to said port;
a hollow needle, said needle being securable to said port; and
means for delivering fluid from said reservoir to said needle, said fluid delivered independently of said ultrasonic energy of said ultrasonic handpiece.

7. The device according to claim 6 wherein said fluid reservoir comprises a syringe.

8. The device according to claim 7 wherein said attaching means comprises at least two clips.

9. The device according to claim 7 wherein said nosepiece is removably securable to said tubing.

10. The device according to claim 7 wherein said nosepiece is preassembled with said tubing.

11. The device according to claim 7, wherein said attachment means further comprises a press fitting, said press fitting connectable to said second end of said length of tubing.

12. The device according to claim 6 wherein said needle is flexible.

13. The device according to claim 12 further comprising a cannula, said cannula allowing a portion of said needle to be held in a prebent arrangement.

14. A device for use with an ultrasonic handpiece and for delivering fluid from a fluid source independently and externally of said handpiece to a dental area, said device comprising:
a nosepiece;
a fluid pathway located in said nosepiece;
means for connecting said fluid pathway to said fluid source;
means for connecting said nosepiece to said handpiece; and
a flexible needle connected to said fluid pathway.

15. The device of claim 14 wherein said needle is capable of transmitting ultrasonic or sonic energy.

16. The device of claim 14 further comprising a cannula located over a portion of said needle, said cannula capable of holding said needle in a prebent position.

17. The device of claim 14 wherein the length of said needle is capable of being shortened.

18. The device of claims 14 wherein said needle comprises an inner layer, a central layer, and an outer layer, wherein said central layer is selected from the group consisting of: flexible stainless steel and alloys thereof, shape memory metals and alloys thereof, or equivalents thereof.

19. The device of claim 17 wherein said inner layer comprises a thermoplastic material.

20. The device of claim 19 wherein said outer layer comprises a thermoplastic material.
